(19) United States
(12) Patent Application Publication
(10) Pub. No.: US 2016/0311294 A1
(43) Pub. Date: Oct. 27, 2016

(54) REGULATED OUTPUT POWER FROM A TRANSPORT REFRIGERATION UNIT

(71) Applicant: Carrier Corporation, Farmington, CT (US)

(72) Inventor: Michael Swab, Acworth, GA (US)

(21) Appl. No.: 15/137,651

(22) Filed: Apr. 25, 2016

Related U.S. Application Data
(60) Provisional application No. 62/153,051, filed on Apr. 27, 2015.

(51) Int. Cl. B60H 1/32; B60P 3/20; B60H 1/00

(52) U.S. Cl. CPC B60H 1/3222; B60H 1/3232; B60H 1/00521; B60P 3/20

(57) ABSTRACT

A transport refrigeration unit includes a source of unregulated AC power; a compressor; a power conditioning module to convert the unregulated AC power to regulated power; and a switch having a first position to connect the source of unregulated AC power to the compressor and a second position to connect the source of unregulated AC power to the power conditioning module.

### CROSS-REFERENCE TO RELATED APPLICATIONS

This application claims the benefit of U.S. provisional patent application serial number 62/153,051, filed Apr. 27, 2015, the entire contents of which are incorporated herein by reference.

### BACKGROUND

The subject matter disclosed herein relates generally to transport refrigeration units, and more particularly to providing regulated output power from an unregulated power source of a transport refrigeration unit.

Transport refrigeration units are used to cool cargo in a trailer or cargo container. Existing transport refrigeration units employ an engine and a generator to produce electrical power (e.g., AC power) to drive the compressor and fans (e.g., evaporator fans, condenser fans). Existing sources of AC power produce unregulated AC power that can vary in voltage and frequency. Operators of the transport refrigeration unit may have a need to power auxiliary devices, but cannot use the AC power from the generator due to the unregulated nature of the AC power.

### BRIEF DESCRIPTION

According to one embodiment, a transport refrigeration unit includes a source of unregulated AC power; a compressor; a power conditioning module to convert the unregulated AC power to regulated power; and a switch having a first position to connect the source of unregulated AC power to the compressor and a second position to connect the source of unregulated AC power to the power conditioning module.

In addition to one or more of the features described above, or as an alternative, further embodiments may include an evaporator fan; wherein the switch in the first position connects the source of unregulated AC power to the evaporator fan.

In addition to one or more of the features described above, or as an alternative, further embodiments may include wherein the power conditioning module is an AC/DC converter to convert the unregulated AC power to regulated DC power.

In addition to one or more of the features described above, or as an alternative, further embodiments may include a DC power connection coupled to the power conditioning module.

In addition to one or more of the features described above, or as an alternative, further embodiments may include wherein the DC power connection comprises a DC power outlet.

In addition to one or more of the features described above, or as an alternative, further embodiments may include a further power conditioning module coupled to the power conditioning module.

In addition to one or more of the features described above, or as an alternative, further embodiments may include wherein the further power conditioning module is a DC/AC converter to convert the regulated DC power to regulated AC power.

In addition to one or more of the features described above, or as an alternative, further embodiments may include an AC power connection coupled to the further power conditioning module.

In addition to one or more of the features described above, or as an alternative, further embodiments may include wherein the AC power connection comprises an AC power outlet.

In addition to one or more of the features described above, or as an alternative, further embodiments may include a controller to move the switch between the first position and the second position in response to a determined operating mode.

In addition to one or more of the features described above, or as an alternative, further embodiments may include wherein the source of unregulated AC power includes an engine and a generator.

According to another embodiment, a method of operating a transport refrigeration unit includes determining to operate the transport refrigeration unit in one of a refrigeration mode and an auxiliary power mode; in the refrigeration mode, directing unregulated AC power to a compressor; and in the auxiliary power mode, directing the unregulated AC power to a power conditioning module.

In addition to one or more of the features described above, or as an alternative, further embodiments may include wherein determining to operate the transport refrigeration unit in one of the refrigeration mode and the auxiliary power mode is in response to a user input.

In addition to one or more of the features described above, or as an alternative, further embodiments may include wherein determining to operate the transport refrigeration unit in one of the refrigeration mode and the auxiliary power mode is in response to a need for refrigeration.

In addition to one or more of the features described above, or as an alternative, further embodiments may include wherein a source of the unregulated AC power includes an engine; wherein directing the unregulated AC power to the power conditioning module includes operating the engine at a constant speed.

### BRIEF DESCRIPTION OF THE DRAWINGS

The foregoing and other features and advantages of embodiments are apparent from the following detailed description taken in conjunction with the accompanying drawings in which:

FIG. 1 depicts a tractor trailer system having a transport refrigeration unit and a cargo compartment in an exemplary embodiment;

FIG. 2 depicts a transport refrigeration unit for a cargo compartment of the tractor trailer system of FIG. 1 in an exemplary embodiment;

FIG. 3 depicts a transport refrigeration unit power system for outputting regulated power in an exemplary embodiment; and

FIG. 4 is a flowchart of a process for operating the transport refrigeration unit power system in an exemplary embodiment

### DETAILED DESCRIPTION

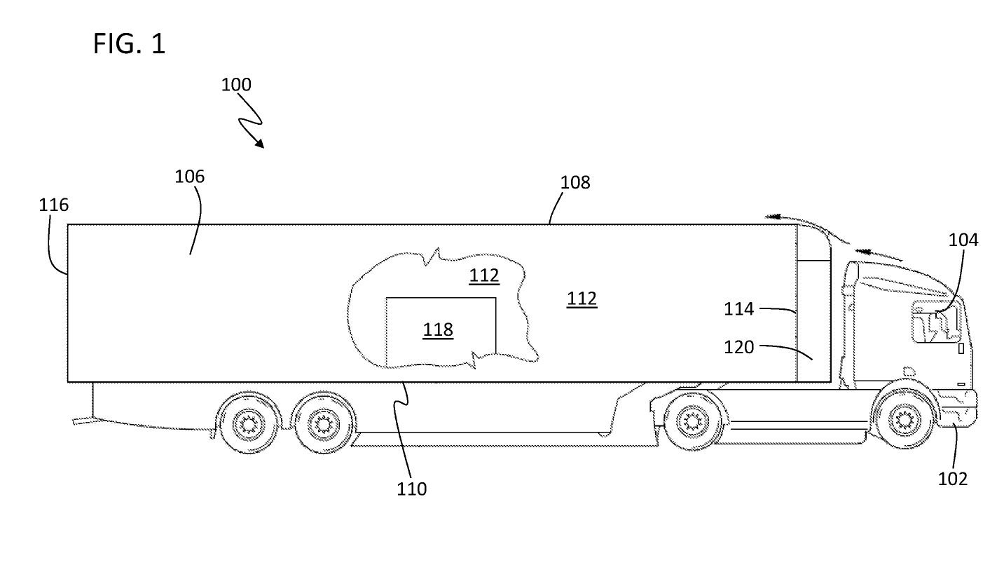

Shown in FIG. 1 is an embodiment of a tractor trailer system 100. The tractor trailer system 100 includes a tractor 102 including an operator's compartment or cab 104 and also including an engine, which acts as the drive system of the tractor trailer system 100. A trailer 106 is coupled to the tractor 102. The trailer 106 is a refrigerated trailer 106 and includes a top wall 108, a directly opposed bottom wall 110, opposed side walls 112, and a front wall 114, with the front wall 114 being closest to the tractor 102. The trailer 106 further includes a door or doors (not shown) at a rear wall 116, opposite the front wall 114. The walls of the trailer 106 define a cargo compartment. The trailer 106 is configured to maintain a cargo 118 located inside the cargo compartment at a selected temperature through the use of a transport refrigeration unit 120 located on the trailer 106. The transport refrigeration unit 120, as shown in FIG. 1, is located at or attached to the front wall 114.

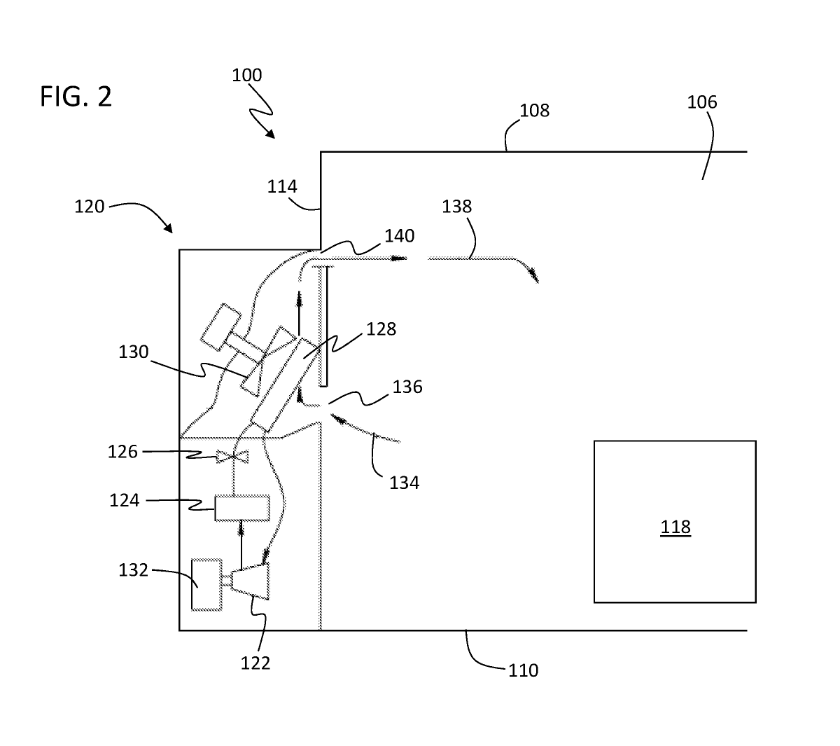

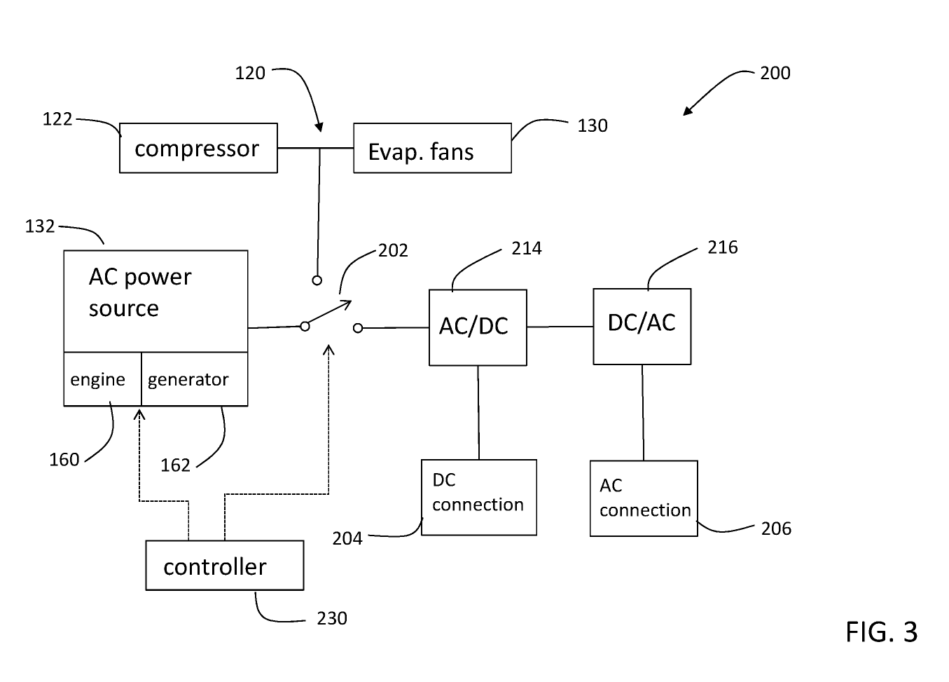

Referring now to FIG. 2, the transport refrigeration unit 120 is shown in more detail. The transport refrigeration unit 120 includes a compressor 122, a condenser 124, an expansion valve 126, an evaporator 128, and an evaporator fan 130. The compressor 122 is operably connected to a AC power source 132 which drives the compressor 122. The AC power source 132 may include an engine and a generator, as described herein with reference to FIG. 3.

Airflow is circulated into and through the cargo compartment of the trailer 106 by means of the transport refrigeration unit 120. A return airflow 134 flows into the transport refrigeration unit 120 from the cargo compartment of the trailer 106 through a refrigeration unit inlet 136, and across the evaporator 128 via the evaporator fan 130, thus cooling the return airflow 134. The cooled return airflow 134, now referred to as supply airflow 138, is supplied into the cargo compartment of the trailer 106 through a refrigeration unit outlet 140, which in some embodiments is located near the top wall 108 of the trailer 106. The supply airflow 138 cools the cargo 118 in the cargo compartment of the trailer 106.

FIG. 3 depicts a transport refrigeration unit power system 200 for outputting conditioned, regulated power in an exemplary embodiment. Shown in FIG. 3 is AC power source 132. As described above, the AC power source 132 may include an internal combustion engine 160 (e.g., a diesel engine) and a generator that produces unregulated AC power. In an exemplary embodiment, the generator 162 generates unregulated, three-phase AC power, with no regulation ability other than controlling the speed of engine 160.

The transport refrigeration unit power system 200 includes a switch 202 that connects the output of AC power source 132 to either the transport refrigeration unit 120 or to auxiliary power connections, such as one or more DC power connections 204 and/or one or more AC power connections 206. When switch 202 is in a first position, the output of the AC power source 132 is connected to the compressor 122 and evaporator fan 130 of the transport refrigeration unit 120. When switch 202 is in a second position, the output of the AC power source 132 is connected to power conditioning modules 214 and 216, which are connected to the one or more DC power connections 204 or one or more AC power connections 206, respectively. A first power conditioning module 214 may be an AC to DC converter. The first power conditioning module 214 receives the unregulated, three-phase AC power from AC power source 132 and generates regulated DC power (e.g., 24 VDC, 200 Amp). The regulated DC power is connected to the one or more DC power connections 204. The one or more DC power connections 204 may include a DC outlet, to which an operator can connect a DC load (e.g., soft drink pumps). The one or more DC power connections 204 may include a connection to a DC load associated with the trailer, such as a lift gate.

A second power conditioning module 216 may be a DC to AC converter. The second power conditioning module 216 receives the regulated DC power from the first power conditioning module 214 and produces regulated AC power (e.g., 120/240 VAC, 20 Amp, 60 Hz). The regulated AC power is connected to the one or more AC power connections 206. The one or more AC power connections 206 may include an AC outlet, to which an operator can connect an AC load (e.g., cash registers, computers). The one or more AC power connections 206 may include a connection to an AC load associated with the trailer (e.g., AC powered hand truck chargers).

A controller 230 controls various aspects of the transport refrigeration unit 120 and the transport refrigeration unit power system 200. Controller 230 can vary the speed of engine 160 depending on which mode of operation is selected. Controller 230 also controls switch 202.

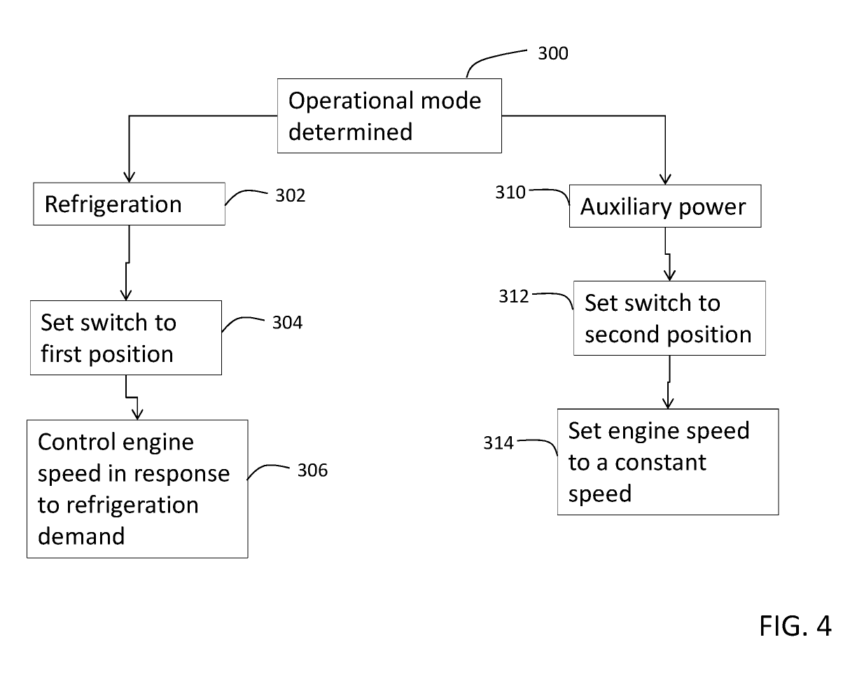

FIG. 4 is a flowchart of a process for operating the transport refrigeration unit power system 200 in an exemplary embodiment. The process may be implemented by controller 230. The process begins at 300 where the operational mode of the transport refrigeration unit power system 200 is determined. The operational mode may be one of refrigeration mode or auxiliary power mode. The operational mode may be selected by a user (e.g., through a user interface coupled to the controller) or may be determined by the controller 230. For example, if the controller 230 determines that there is no current refrigeration demand, the controller 230 may automatically switch to auxiliary power mode (e.g., to charge batteries, etc.).

If refrigeration mode is determined, as shown at 302, flow proceeds to 304 where the controller 230 moves switch 202 to the first position. This connects the unregulated AC power from the AC power source 132 to the transport refrigeration unit 120 (e.g., to compressor 122 and evaporator fan 130). At 306, the controller 230 regulates the speed of the engine 160 in response to refrigeration demand. The system stays in refrigeration mode until a mode change is determined.

If at 300, auxiliary power mode is determined, as shown at 310, flow proceeds to 312 where the controller 230 moves switch 202 to the second position. This connects the unregulated AC power from the AC power source 132 to power conditioning modules 214 and 216. At 314, the controller 230 regulates the speed of the engine 160 to be at a fixed speed to establish a stabile frequency (e.g., 60 Hz) of the unregulated AC power from the generator 162. The system stays in auxiliary power mode until a mode change is determined.

Embodiments allow a transport refrigeration unit power system, having an unregulated AC power source, to supply regulated DC power and regulated AC power when refrigeration is not needed.

While the disclosure has been provided in detail in connection with only a limited number of embodiments, it should be readily understood that the present disclosure is not limited to such disclosed embodiments. Rather, embodiments can be modified to incorporate any number of variations, alterations, substitutions, combination, sub-combination, or equivalent arrangements not heretofore described, but which are commensurate with the spirit and scope of the disclosure. Additionally, while various embodiments have been described, it is to be understood that aspects of the disclosure may include only some of the described embodiments. Accordingly, embodiments are not to be seen as limited by the foregoing description, but only limited by the scope of the appended claims.

What is claimed is:

1. A transport refrigeration unit comprising:
a source of unregulated AC power;
a compressor;
a power conditioning module to convert the unregulated AC power to regulated power; and
a switch having a first position to connect the source of unregulated AC power to the compressor and a second position to connect the source of unregulated AC power to the power conditioning module.

2. The transport refrigeration unit of claim 1, further comprising:
an evaporator fan;
wherein the switch in the first position connects the source of unregulated AC power to the evaporator fan.

3. The transport refrigeration unit of claim 1, wherein:
the power conditioning module is an AC/DC converter to convert the unregulated AC power to regulated DC power.

4. The transport refrigeration unit of claim 3, further comprising:
a DC power connection coupled to the power conditioning module.

5. The transport refrigeration unit of claim 4, wherein:
the DC power connection comprises a DC power outlet.

6. The transport refrigeration unit of claim 3, further comprising:
a further power conditioning module coupled to the power conditioning module.

7. The transport refrigeration unit of claim 6, wherein:
the further power conditioning module is a DC/AC converter to convert the regulated DC power to regulated AC power.

8. The transport refrigeration unit of claim 7, further comprising:
an AC power connection coupled to the further power conditioning module.

9. The transport refrigeration unit of claim 8, wherein:
the AC power connection comprises an AC power outlet.

10. The transport refrigeration unit of claim 1, further comprising:
a controller to move the switch between the first position and the second position in response to a determined operating mode.

11. The transport refrigeration unit of claim 1,
wherein the source of unregulated AC power includes an engine and a generator.

12. A method of operating a transport refrigeration unit, the method comprising:
determining to operate the transport refrigeration unit in one of a refrigeration mode and an auxiliary power mode;
in the refrigeration mode, directing unregulated AC power to a compressor; and
in the auxiliary power mode, directing the unregulated AC power to a power conditioning module.

13. The method of claim 12, wherein:
determining to operate the transport refrigeration unit in one of the refrigeration mode and the auxiliary power mode is in response to a user input.

14. The method of claim 12, wherein:
determining to operate the transport refrigeration unit in one of the refrigeration mode and the auxiliary power mode is in response to a need for refrigeration.

15. The method of claim 12, wherein:
a source of the unregulated AC power includes an engine;
wherein directing the unregulated AC power to the power conditioning module includes operating the engine at a constant speed.
